(19) United States
(12) Patent Application Publication
(10) Pub. No.: US 2015/0178665 A1
(43) Pub. Date: Jun. 25, 2015

(54) Equipment Management System

(71) Applicant: Jose Rodriguez, Newark, NJ (US)

(72) Inventor: Jose Rodriguez, Newark, NJ (US)

(21) Appl. No.: 14/137,659

(22) Filed: Dec. 20, 2013

(51) Int. Cl. G06Q 10/06; G06Q 10/00

(52) U.S. Cl. CPC G06Q 10/063114; G06Q 10/20

(57) ABSTRACT

Systems are disclosed herein for the efficient management of building equipment.

### CLAIM OF PRIORITY

This filing is related to and claims priority from provisional application No. 61/739,766 filed on Dec. 20, 2012 which is incorporated by reference herein in its entirety.

### BACKGROUND/FIELD

Within the field of facilities management and maintenance among multi-location facilities, it is often necessary to keep track of large numbers of similar pieces of equipment, including for instance HVAC equipment such as pumps, compressors, boilers, etc., security equipment such as cameras, servers, monitors, etc., Consequently, a system is disclosed herein which provides for effective inventory and review of the maintenance and other data pertaining to unique pieces of equipment.

### SUMMARY

According to certain embodiments of the present disclosure described herein, a system for managing physical equipment installed at a plurality of locations includes a fixed-location server component, with the server component having a plurality of data stores corresponding to the units of physical equipment as well as the maintenance data for the equipment and subsystems thereof and a queue of maintenance tasks therefor; a portable client component for use by a technician communicatively coupled to the server component and capable of accessing and modifying the data stores disposed therein; wherein upon request for a maintenance task upon the equipment by a user, the maintenance task is placed into the appropriate queue for action upon by the server component and transmitted to the portable client of the appropriate technician.

According to further embodiments of the present disclosure, the fixed-location server component is located at a remote location and accessible to the portable client via an internet connection, cellular connection, radio connection, or combination thereof.

According to further embodiments of the present disclosure, the units of equipment are catalogued according to general areas or rooms within which they are disposed.

According to further embodiments of the present disclosure, units of equipment are catalogued according to the building within which they are disposed.

According to further embodiments of the present disclosure, units of equipment are catalogued according to the building site within which they are disposed.

According to further embodiments of the present disclosure, there is a machine-readable tag which can be placed upon equipment, buildings, areas, or sites which is readable by the portable client and whose data corresponds to an associated record within the system.

According to further embodiments of the present disclosure, the machine-readable format of the tag is one of the following, bar code, 2-dimensional bar code, NFC device, RFID device, or encoded image.

According to further embodiments of the present disclosure, there is a human-readable tag which can be placed upon equipment, buildings, areas, or sites which when manually entered into the portable client corresponds to associated records for that equipment, building, area, or site within the system.

According to further embodiments of the present disclosure, the portable client is communicatively connected to a machine-vision component including for instance a barcode reader or optical imager.

According to further embodiments of the present disclosure, the server is capable of retaining images of equipment.

According to further embodiments of the present disclosure, the client is capable of transmitting images to the server.

According to further embodiments of the present disclosure, the server stores information related to the equipment including for instance whitepapers, service manuals, service intervals, and part numbers which can accessed based on given equipment types.

According to further embodiments of the present disclosure, the server or client is capable of retrieving information related to the equipment including for instance whitepapers, service manuals, service intervals, and part numbers over an internet connection from a third party, including for instance the equipment manufacturer.

According to further embodiments of the present disclosure, either the server or client component is capable of querying the data stores of the server to generate reports, wherein query criteria are selected from at least one of a site's history, a building's history, a worker or maintenance team's history, a cost history, or an equipment type.

According to further embodiments of the present disclosure, the cost of maintenance tasks are recorded within an associated data store in terms of both at least one of labor costs and part costs.

According to further embodiments of the present disclosure, the equipment specifically includes heating, ventilation, and air conditioning equipment including for instance pumps, compressors, boilers, heaters, and condensers.

According to further embodiments of the present disclosure, the equipment specifically includes security equipment including for instance cameras, sensors, monitoring devices, workstations, recording devices, access means such as electronic locks, and gates.

### BRIEF DESCRIPTION OF THE FIGURES

In the figures, which are not necessarily drawn to scale, like numerals describe substantially similar components throughout the several views. The drawings illustrate generally, by way of example, but not by way of limitation, various embodiments discussed in the claims of the present document. For FIGS. 2 through 12, exemplary embodiments of a graphical user interface are shown which are operatively configured for managing the interactions of various users with the system claimed in the present application.

FIG. 1 shows a flow chart of the logic of a technician visiting a new site.

FIG. 2 shows an embodiment of an area and equipment listing within an embodiment of an equipment management system.

FIG. 3 shows a contractor listing within an embodiment of an equipment management system.

FIG. 4 shows a districts listing within an embodiment of an equipment management system.

FIG. 5 shows an equipment report within an embodiment of an equipment management system.

FIG. 6 shows a facilities page within an embodiment of an equipment management system.

FIG. 7 shows an inventory performance report within an embodiment of an equipment management system.

FIG. 8 shows a locations/site page within an embodiment of an equipment management system.

FIG. 9 shows a manufacturers page within an embodiment of an equipment management system.

FIG. 10 shows an embodiment of a regions listing within an embodiment of an equipment management system.

FIG. 11 shows an embodiment of an inventory schedule interface within an embodiment of an equipment management system.

FIG. 12 shows an embodiment of a synchronization screen within an embodiment of an equipment management system.

FIG. 13 shows an embodiment of a user activity report within an embodiment of an equipment management system.

### DETAILED DESCRIPTION OF THE FIGURES

According to a first embodiment of the present disclosure, an inventory system comprises a first, server software component operable on a computer running at a fixed location, and at least one remote component operable on a portable computer communicatively coupled to the first via a network.

The server portion of a maintenance and inventory system includes computer-implemented hierarchical data structures with unique data stores for a given geographic district, regions within each geographic district defined as a subset of that district, locations within each region defined as a subset of that region, buildings within each location defined as a subset of that location, areas within each facility defined as a subset of that building, and discrete units of equipment within each area defined as a subset of that area.

Each element of the hierarchy corresponds to and stores data relating to the physical structures it represents. The data store for a hypothetical district A represents a set of states within the United States of America and contains information about the district's boundaries, its administrative and maintenance personnel and contact information therefor, information about procedures for that district, locations disposed therein, the maintenance policies for various types of equipment that apply to the district, images thereof, a record of the pending and already executed maintenance tasks therefor, and other relevant information.

Similarly, a hypothetical region B5 within District B represents a subset of states within District B and contains information about the facilities within the state's; locations, its administrative and maintenance personnel and contact information therefor, information about procedures for within the location, buildings disposed therein, the maintenance policies for various types of equipment that apply to the district, images thereof, a record of the pending and already executed maintenance tasks therefor, and other relevant information.

Similarly, a hypothetical location in region C9 within District C represents facilities in subset of States and contains information about the location's whereabouts, its administrative and maintenance personnel and contact information therefor, information about procedures for within the base, buildings disposed therein, the maintenance policies for various types of equipment that apply to the district, images thereof, a record of the pending and already executed maintenance tasks therefor, and other relevant information.

Further, a hypothetical facility D within Region C9 represents a specific building at the location and contains information about the building's location, its administrative and maintenance personnel and contact information therefor, information about procedures that apply to facility D, areas disposed therein, the maintenance policies for various types of equipment that apply to the district, images thereof, a record of the pending and already executed maintenance tasks therefor, and other relevant information.

Further still, a hypothetical area E within facility D represents a specific room or space within the building and contains information about the area's location, its administrative and maintenance personnel and contact information therefor, information about procedures that apply to area E, the units of equipment disposed therein, the maintenance policies therefor, images thereof a record of the pending and already executed maintenance tasks therefor, and other relevant information.

Further still, a hypothetical piece of equipment F is an air conditioning unit within area E, and contains information about equipment F's location within its administrative and maintenance personnel and contact information therefor, information about procedures that apply to equipment F, the subsystems thereof such as filters, compressors, or belts, the maintenance policies therefor, images thereof, a record of the pending and already executed maintenance tasks therefor, and other relevant information.

The remote component in the given exemplary embodiment of the present disclosure is a laptop computer connected to the server component via cellular and/or internet connectivity that may be transported to a location. Additionally, the remote component may have optional barcode printing and scanning capability in order to aide in identification and management of the various elements managed by the system.

For each equipment record, option data units include, but are not limited to nomenclature of equipment (e.g. water heater, dryer, boiler, fan, chiller), location of equipment (building number/name, floor, room number, roof, outside areas), photo of equipment, photo of data plate, manufacturer, model number, serial number, part number, date of manufacture, capacity of equipment, fuel (e.g. natural gas, propane, electric, oil), BTU rating, horsepower, amps, volts, watts, size, hours, size of filter, type of filter, number of filters, type of belts, size of belts, number of belts, size of fuel tanks, motor ratings, vent size and type.

User roles and hierarchy within the server roughly correspond to the administrative and geographical divisions described above. For instance, a system administrator will have privileges to access and modify any records within the system, while a contractor/subcontractor will only have privileges to access and modify records pertaining to the buildings and subsystems that they are authorized to work with. Between the two, the various hierarchical command relationships between managers and subordinates are represented within user roles and permissions within the system. Where such relationships are appropriate as entered into the data record for a given piece of equipment or location, maintenance requests are only sent to the queue of a given maintenance personnel upon approval by the appropriate superior.

There is a data store within the server component that maintains a record of known models of HVAC components as well as their requisite information such as part numbers, duty cycles, part replacement intervals, power ratings, etc. such that when a new piece of equipment is entered into the system, the technician entering the data is given the option to assign such pre-stored values to the present piece of equipment. As the system operates, the server component places the given piece of equipment in the maintenance queue as replacement or repair of parts or fluids is needed. The system can also provide the contractor/subcontractor user the ability to manage their respective invoicing for services (maintenance performed, equipment repaired/replaced, etc.) rendered. This includes, but is not limited to creating invoices, modifying invoices, tracking invoices, and searching for open or closed invoices based on the status and content of that invoice.

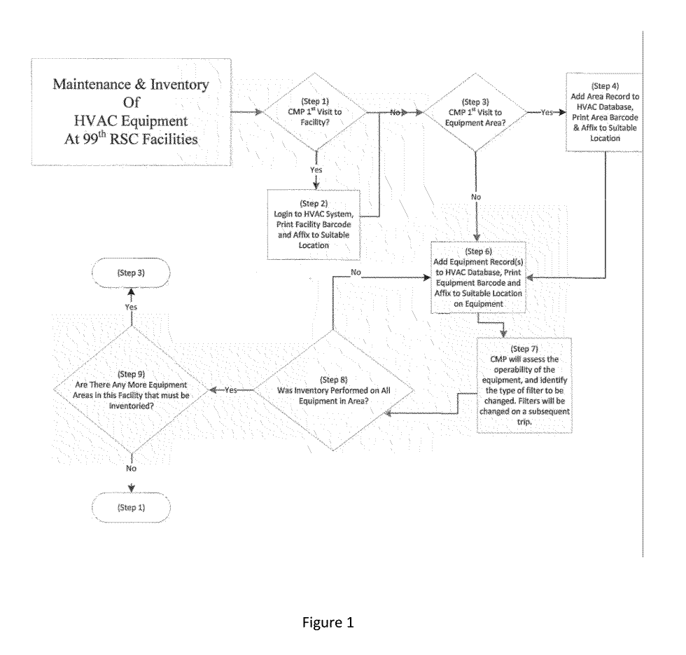

Referring now to FIG. 1, an exemplary method of using the system will now be described. Initially, a contractor maintenance personnel (CMP) authorized to work at a given facility arrives at the facility and checks on the server (SC), via the remote component (RC) for whether the given facility has been visited before. If it has not, the CMP creates a record for the facility within the SC and prints a barcode on his RC with the barcode identifying the facility within the SC. Next, the CMP affixes the barcode to a suitable location on the facility.

Next, the CMP scans the previously existing barcode, if it exists, and proceeds to the first area or equipment location (EL) in the facility. Upon arriving at the EL, the CMP checks to see whether the given EL has been visited before. If it has not, the CMP creates a record for the facility within the SC and prints a barcode on his RC with the barcode identifying the EL within the SC.

Next, the CMP repeats the aforementioned steps, checking to see if the individual pieces of equipment present at the EL have been entered into the system, and if not, entering their data.

Next, the CMP checks the maintenance queue for each piece of equipment in the EL and performs any maintenance tasks required including for instance changing an air filter or a drive belt and updates the equipment record within the SC to correspond to such changes.

An exemplary method of assigning a maintenance task will now be described. Initially, a maintenance request is entered into the system by a user, including for instance a building manager or service technician who observes operating issues or deficiencies with a given piece of equipment. Per the data stored for the equipment and its location, site, and region, the request is passed to the appropriate administrative contact that approves the service request and is given the option of assigning it to a subordinate down the chain of command to execute. Upon successful execution of the maintenance task, such is recorded within the server component.

For instances where a personnel or staff member executing a monitoring or service task is going to be outside of the transmission range of the data network employed by the system, the remote terminal is capable of (1) storing information necessary for a site visit or service call in its local memory for viewing later by the staff or personnel member and (2) capturing changes or data input by the staff or personnel member in a queue that is synchronized with the data server once the remote terminal is once again within transmission range.

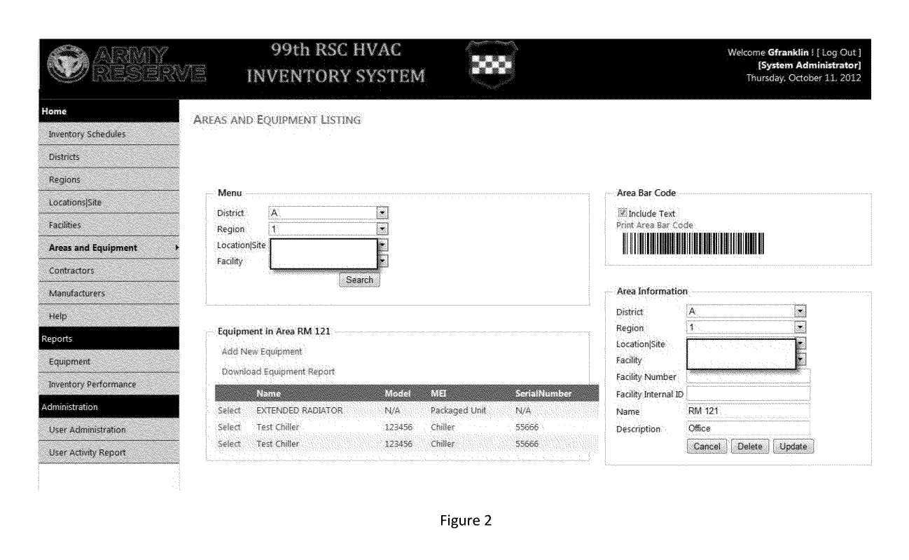

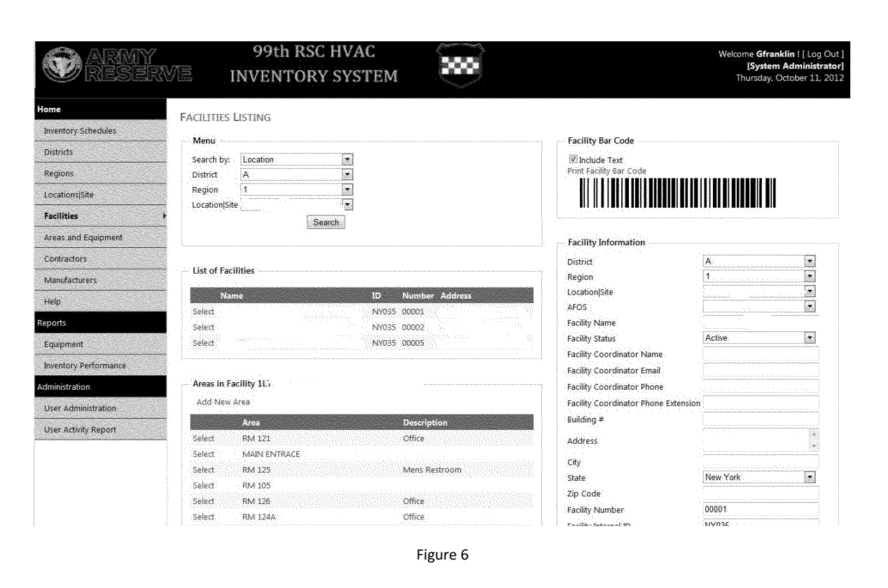

Referring now to FIGS. 2 through 13 together, an exemplary embodiment of a GUI configured to manage the interactions of a plurality of users and the system will now be shown and described. The GUI is implemented on a web server which displays a plurality of pages that allow a user to search for, view, and/or edit data stored within the system. In the examples that follow, the general manner of operation is that queries for references of locations, buildings, equipment, etc. are generated using the section labeled “menu” in the upper left-hand corner of the screen. For instance, in FIG. 6, this is the “Search by”, “District”, “Region”, and “Location” drop-downs.

Next, lists of assets matching a given query are displayed below the menu area. In the example shown in FIG. 6, this is the list of facilities. Each list contains itemized data regarding a resource, including for instance its unique identifier code within the system, location, description, or other data as will be apparent from the preceding and following text. Within the list(s) of assets, individual assets may be selected by a user by clicking “select”. Upon such action, the system either displays a second, child list of available options per the aforedescribed hierarchy. An example of a child list is the listing of subset areas (entrance, rm 121, rm 105, etc.) available within a selected facility such as shown in the example in FIG. 6, 11.

Upon selection of a data item within a list, detailed information about that data item is displayed along the right-hand side of the screen. This includes for instance that appropriate barcode and facility information as shown for example in FIG. 6. Given adequate user permissions, this data may be statically displayed as shown in the barcode in FIG. 6, or editable as shown in the “facility information” form in FIG. 6.

Referring now to FIG. 2, an areas and equipment listing is shown. Via the GUI shown, a user may search for areas and equipment, returning a listing of pertinent data for each record. This search may be narrowed by selecting from at least one of the district, region, location, and facility. Additionally, this GUI displays and allows printing of the pertinent area bar code as well as the area information.

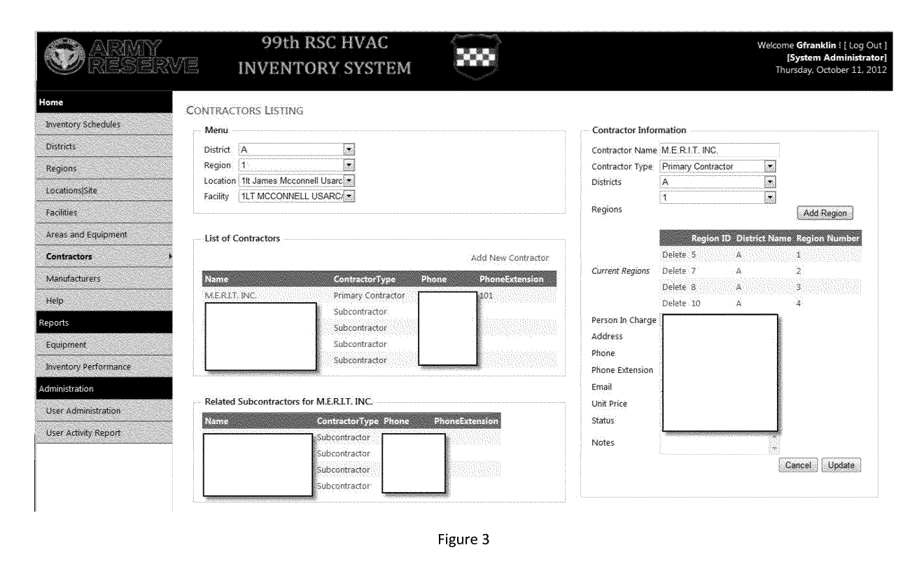

Referring now to FIG. 3, a contractors listing GUI is shown. Via the GUI shown, a user may search for contractors which meet a given set of criteria including at least one of a given district, region, location, or facility. For the contractors displayed, that contractor's type (Primary/Subcontractor), Phone number, Extension is shown in the search results list at left. Upon the right side of the GUI is shown a detail screen for a given contractor/vendor. Within the detail screen, the details for a given contractor/vendor may be viewed and edited. These details include but are not limited to the contractor's/vendor's name, districts/areas served, person in charge, address, phone numbers and other contact information, work status, notes, and additional notes.

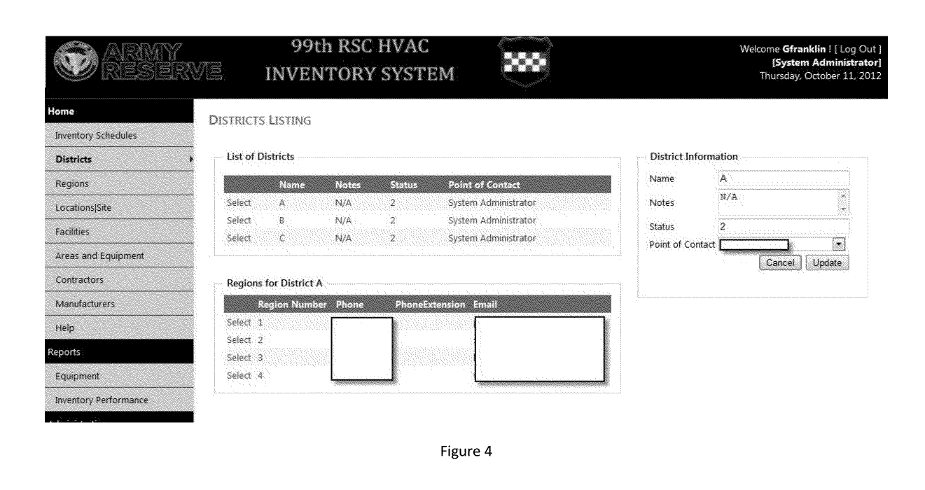

Referring now to FIG. 4, a districts listing GUI is shown. Via the GUI shown, the districts and regions within a given area may be viewed and managed.

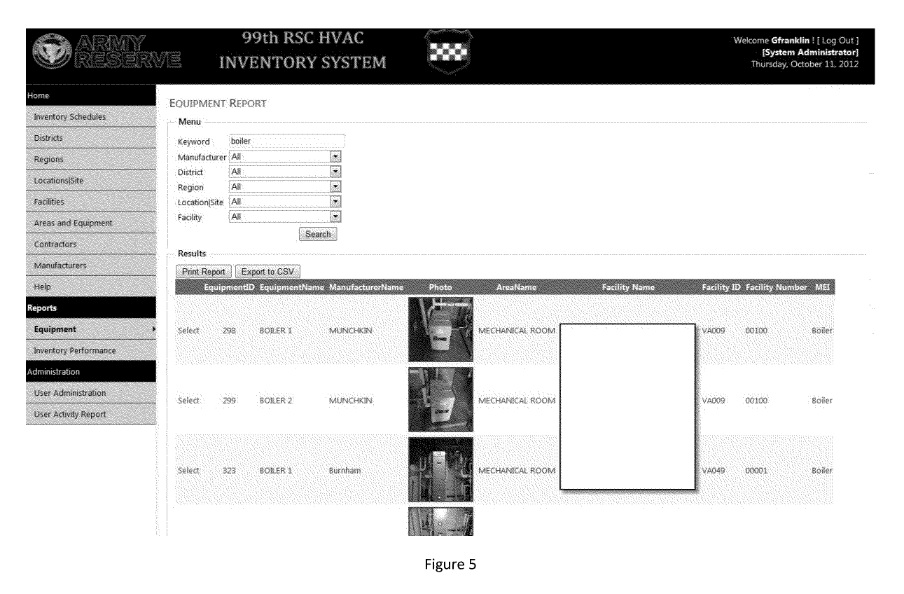

Referring now to FIG. 5, an equipment report GUI is shown. Using the equipment report GUI, a user may search for equipment records within the system that match at least one of the following search types; keywords, manufacturer, district, region, location, or facility. The results of the search are shown as a list with the Equipment ID, Equipment Name, Manufacturer Name, and Photograph of the equipment, area name, facility name, and other pertinent data. Selecting a given piece of equipment will provide additional information about the piece of equipment as well as the ability to edit its information and/or service record.

Referring now to FIG. 6, a Facilities listing GUI is shown. The facilities listing GUI allows a user to search for facilities as well as the areas therewithin. The search criteria for this include at least one of the location, district, region, location, or site of the facilities. The pertinent information regarding contact persons, status, and locations is shown at right in the figure along with the relevant barcode.

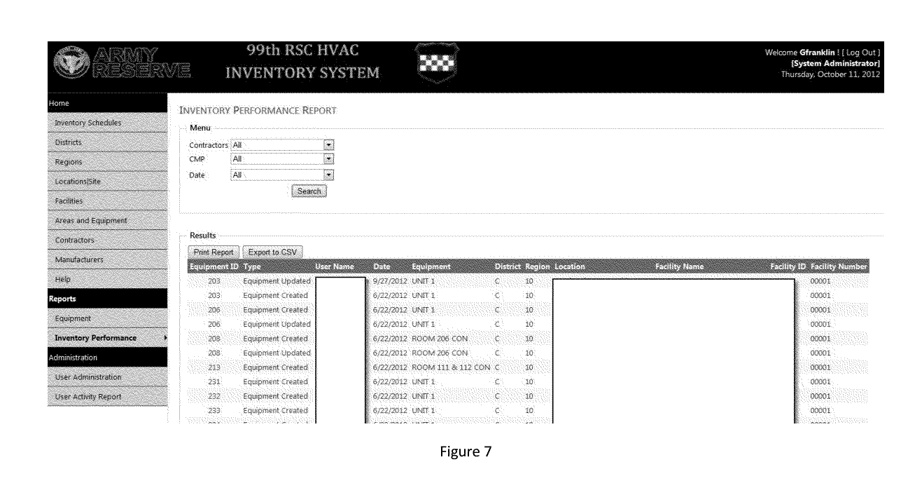

Referring now to FIG. 7, an inventory performance report GUI is shown. Using this GUI, a user may display, select, and modify the performance and maintenance records for equipment disposed at a given piece of equipment. Given a query of at least one of a contractor, date, or other criteria, a listing of equipment is displayed with its equipment ID code, as well as a record of the service notices and updates to the equipment and who made said changes.

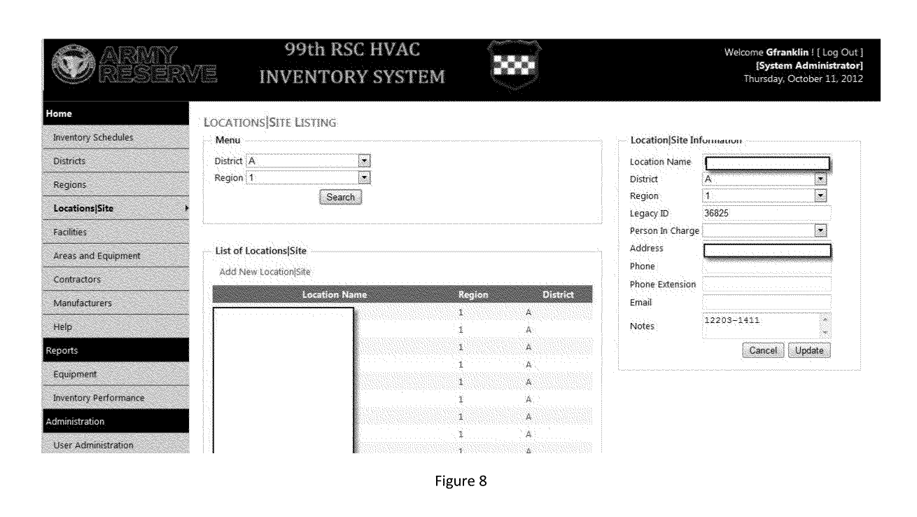

Referring now to FIG. 8, a locations/site listing GUI is shown. Via this GUI, a user may query at least one of the district and region and receive in response a list of locations that match the aforementioned criteria. For each location, information is shown in an additional window at right including the name, district, region, ID code, person in charge, address, contact information, notes, barcode, or other pertinent data regarding the location.

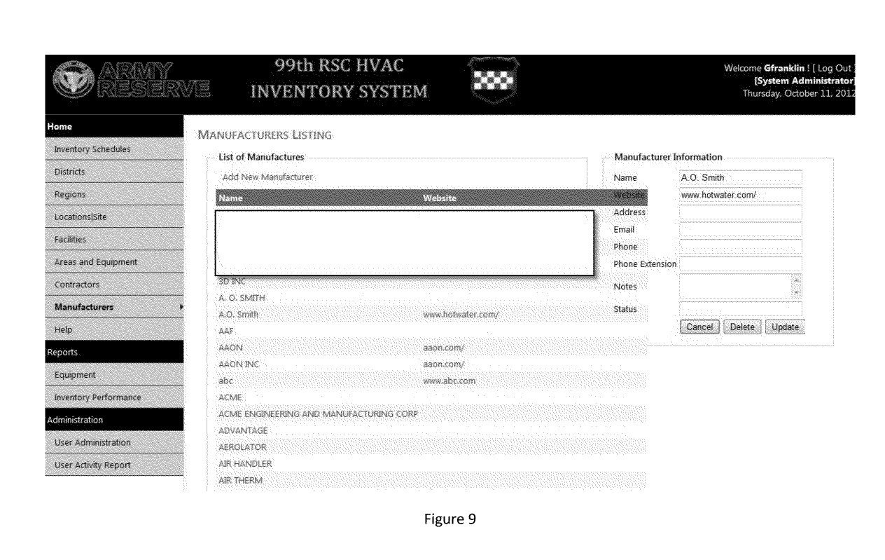

Referring now to FIG. 9, a manufacturers listing GUI is shown. Via this GUI, a user is presented with a listing of manufacturers known within the system as well as their further information for each in the right-hand segment including for instance contact information, notes, status, etc.

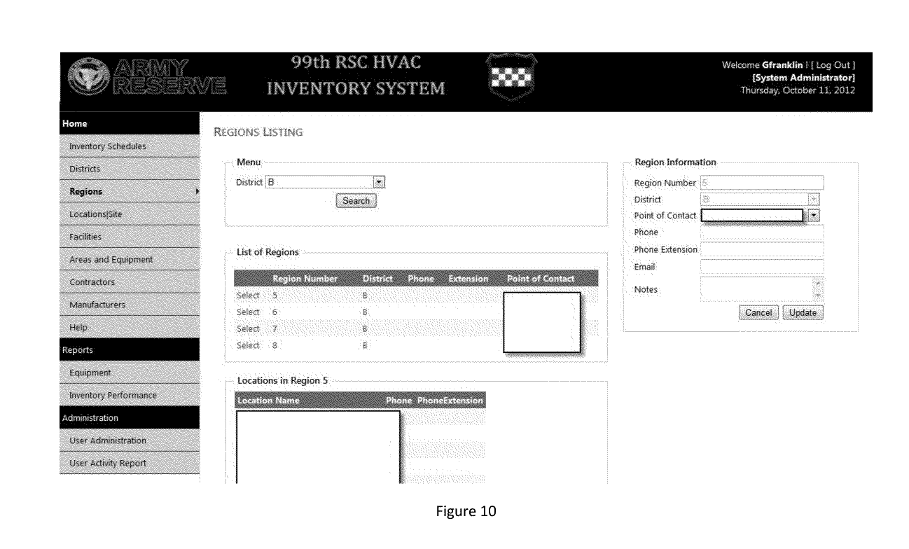

Referring now to FIG. 10, a regions listing GUI is shown. Via this GUI, a user may search for, retrieve, and edit the listing of regions within a district as well as the list of locations within a selected region. There is an additional information window at right which allows the user to view or edit additional data including for instance the region, district identifier, point of contact, contact information, and notes.

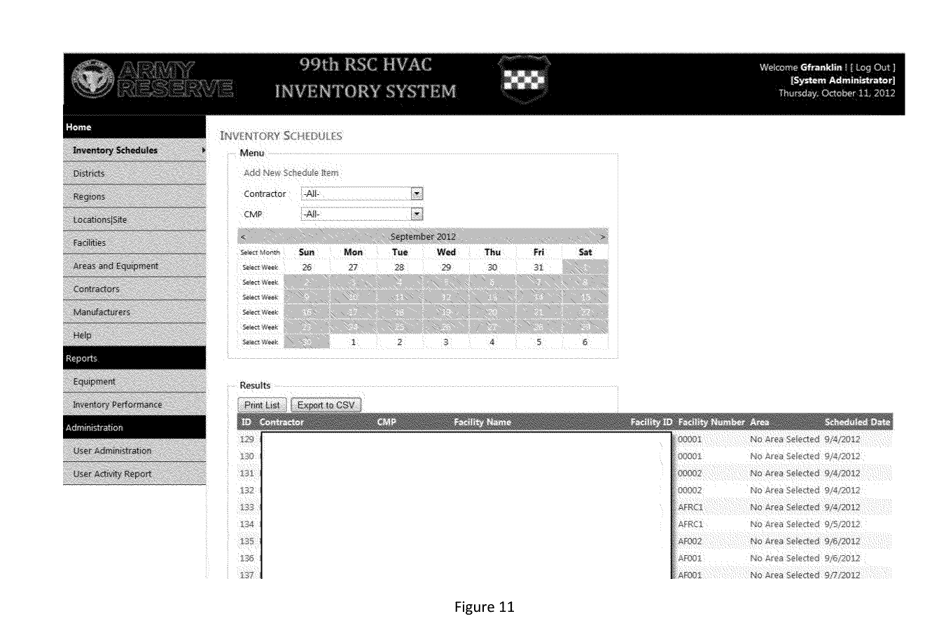

Referring now to FIG. 11, a GUI of inventory schedules is shown. Via this interface, a user may view or edit scheduled service/maintenance events for a given piece of equipment or type of equipment managed by the system including for instance filter changes and replacements, belt, compressor, or other parts servicing, spot checks upon the function of a given piece of equipment, or other maintenance tasks as may be deemed appropriate from time to time.

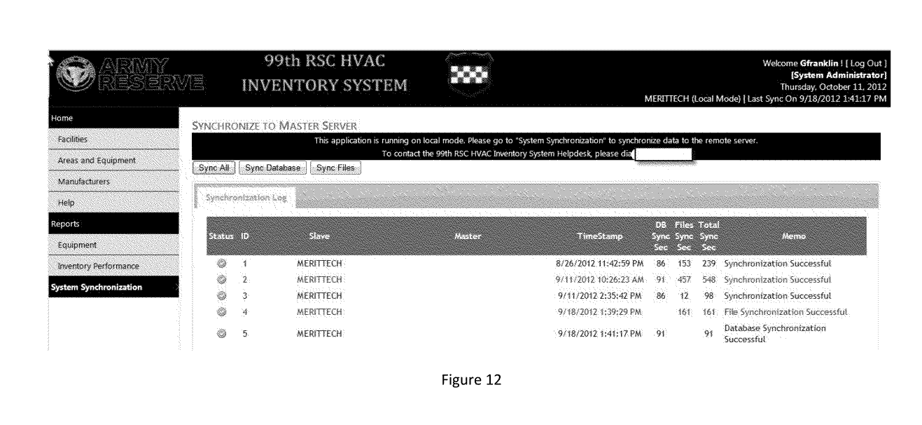

With reference to FIG. 12, a GUI of a synchronization screen is shown. This interface displays the record and status of synchronizations initiated by a user who has made changes to records within the system without direct access thereto per the description in paragraph [35] above.

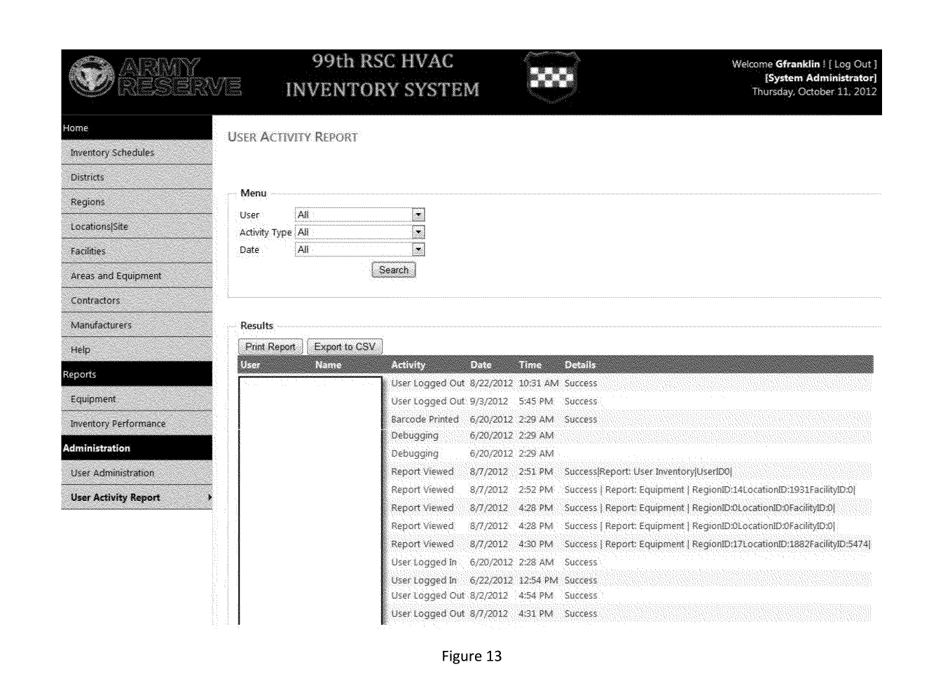

Referring now to FIG. 13, a user activity report is shown. Using this GUI, an administrator may query the recorded activities of users of the system based on at least one of user name, activity type, or date. The results are displayed in rows with information regarding the activity, the actor, date, time, details, and status.

Although the foregoing has been described with respect to a webpage viewable within a browser window, Functionally similar embodiments within the scope of the appended claim are attainable using stand-alone applications.

Further, while an equipment management system has been described and illustrated in conjunction with a number of specific configurations and methods, those skilled in the art will appreciate that, variations and modifications may be made without departing from the principles herein illustrated, described, and claimed. The present invention, as defined by the appended claim, may be embodied in other specific forms without departing from its spirit or essential characteristics. The configurations described herein are to be considered in all respects as only illustrative, and not restrictive. All changes which come within the meaning and range of equivalency of the claim are to be embraced within its scope.

What is claimed is:

1. A system for managing physical equipment installed at a plurality of locations, the system comprising;
a fixed-location server component, with the server component having a plurality of data stores corresponding to the units of physical equipment as well as the maintenance data for the equipment and subsystems thereof and a queue of maintenance tasks therefor;
a portable client component for use by a technician communicatively coupled to the server component and capable of accessing and modifying the data stores disposed therein;
wherein upon request for a maintenance task upon the equipment by a user, the maintenance task is placed into the appropriate queue for action upon by the server component and transmitted to the portable client of the appropriate technician.

2. The system of claim 1, wherein the fixed-location server component is located at a remote location and accessible to the portable client via an internet connection, cellular connection, radio connection, or combination thereof.

3. The system of claim 1, wherein the units of equipment are catalogued according to general areas or rooms within which they are disposed.

4. The system of claim 1, wherein units of equipment are catalogued according to the building within which they are disposed.

5. The system of claim 1, wherein units of equipment are catalogued according to the building site within which they are disposed.

6. The system of claim 1, wherein there is a machine-readable tag which can be placed upon equipment, buildings, areas, or sites which is readable by the portable client and whose data corresponds to an associated record within the system.

7. The system of claim 6, wherein the machine-readable format of the tag is one of the following, bar code, 2-dimensional bar code, NFC device, RFID device, or encoded image.

8. The system of claim 1, wherein there is a human-readable tag which can be placed upon equipment, buildings, areas, or sites which when manually entered into the portable client corresponds to associated records for that equipment, building, area, or site within the system.

9. The system of claim 6, wherein the portable client is communicatively connected to a machine-vision component including for instance a barcode reader or optical imager.

10. The system of claim 1, Server is capable of retaining images of equipment.

11. The system of claim 10, wherein the client is capable of transmitting images to the server.

12. The system of claim 1, wherein the server stores information related to the equipment including for instance whitepapers, service manuals, service intervals, and part numbers which can accessed based on given equipment types.

13. The system of claim 1, where the server or client is capable of retrieving information related to the equipment including for instance whitepapers, service manuals, service intervals, and part numbers over an internet connection from a third party, including for instance the equipment manufacturer.

14. The system of claim 1, wherein either the server or client component is capable of querying the data stores of the server to generate reports, wherein query criteria are selected from at least one of a site's history, a building's history, a worker or maintenance team's history, a cost history, or an equipment type.

15. The system of claim 1, wherein the cost of maintenance tasks are recorded within an associated data store in terms of both at least one of labor costs and part costs.

16. The system of claim 1, wherein the equipment specifically includes heating, ventilation, and air conditioning equipment including for instance pumps, compressors, boilers, heaters, and condensers.

17. The system of claim 1, wherein the equipment specifically includes security equipment including for instance cameras, sensors, monitoring devices, workstations, recording devices, access means such as electronic locks, and gates.

18. The system of claim 1, wherein in the event that the portable client is temporarily out of contact with the server component, the portable client is capable of storing a local version of changes which need to be propagated out to the server component and transmitting them to the server component when a wireless connection is re-established.
